(19) United States
(12) Patent Application Publication
(10) Pub. No.: US 2002/0073000 A1
(43) Pub. Date: Jun. 13, 2002

(54) System and method for implementing a wireless network in a service center for generating a repair order

(76) Inventor: Mike Sage, Woodland Hills, CA (US)

Correspondence Address: Manhattan Project.Net, 23440 Hawthorne Boulevard, Suite 21, Torrance, CA, 90505, US

(21) Appl. No.: 09/736,649

(22) Filed: Dec. 13, 2000

Related U.S. Application Data
(60) Provisional application No. 60/202,315, filed on May 5, 2000.

(51) Int. Cl. G06F 17/60

(52) U.S. Cl. 705/29; 705/1

(57) ABSTRACT

In an embodiment, a portable device is provided with a scanner that enables a user to scan a vehicle identifier on a vehicle. The vehicle identifier may be transmitted over a wireless connection to a networked computer system including one or more databases including information about the vehicle associated with the vehicle identifier. This vehicle information, which may include warranty, owner, service history, and production information, may be transmitted to the portable device for display on the device's display screen. Information may be entered into the portable device and transmitted to a wireless network server. The entered information may be used to update the databases and to prepare a repair order.

### CROSS-REFERENCE TO RELATED APPLICATIONS

This application claims priority to U.S. Provisional Patent Application Serial No. 60/202,315, filed on May 5, 2000.

### BACKGROUND

Vehicle owners may visit an automotive service center for routine maintenance, repairs that may or may not be covered under the manufacturer warranty, and unscheduled repairs. A service writer may use information unique to a customer's vehicle, e.g., the Vehicle Identification Number (VIN), to determine repairs and services that may be covered under the manufacturer warranty, as well as service campaigns and recalls offered by the manufacturer. Service campaigns may be offered by manufacturers to correct certain design or equipment defects. Recalls may be offered by manufacturers to correct safety hazards, for example, faulty seat belt mechanisms. Repairs performed under any of these service types may provide additional revenue for the individual dealer service center.

Service writers may use this vehicle information to generate a repair order (RO) for a particular customer visit.

The vehicle information may indicate that the vehicle is eligible for additional repairs of which the vehicle owner may not be aware. It is therefore advantageous for the service writer to have comprehensive and ready access to information about the vehicle. It may be desirable to enable the service writer to access this vehicle information and generate a repair order remotely, at the customer's vehicle, when the service writer meets the customer in the service drive.

### SUMMARY

In an embodiment, a portable device is provided with a scanner that enables a user to scan a vehicle identifier on a vehicle. The vehicle identifier may be transmitted over a wireless connection to a networked computer system including one or more databases including information about the vehicle associated with the vehicle identifier. This vehicle information, which may include warranty, owner, service history, and production information, may be transmitted to the portable device for display on the device's display screen. Information may be entered into the portable device and transmitted to a wireless network server. The entered information may be used to update the databases and to prepare a repair order.

The details of one or more embodiments of the invention are set forth in the accompanying drawings and the description below, other features, objects, and advantages of the invention will be apparent from the description and drawings, and from the claims.

### DESCRIPTION OF DRAWINGS

FIG. 1 is a portable device according to an embodiment.

FIG. 2 is a networked computer system for generating and remotely displaying a repair order according to an embodiment.

FIG. 3 is a flow chart describing a process for generating and displaying the repair order according to an embodiment.

FIG. 4 is a display screen including vehicle information that may be displayed on the portable device of FIG. 1 according to an embodiment.

FIG. 5 is a display screen including a menu of options that may be displayed on the portable device of FIG. 1 according to an embodiment.

### DETAILED DESCRIPTION

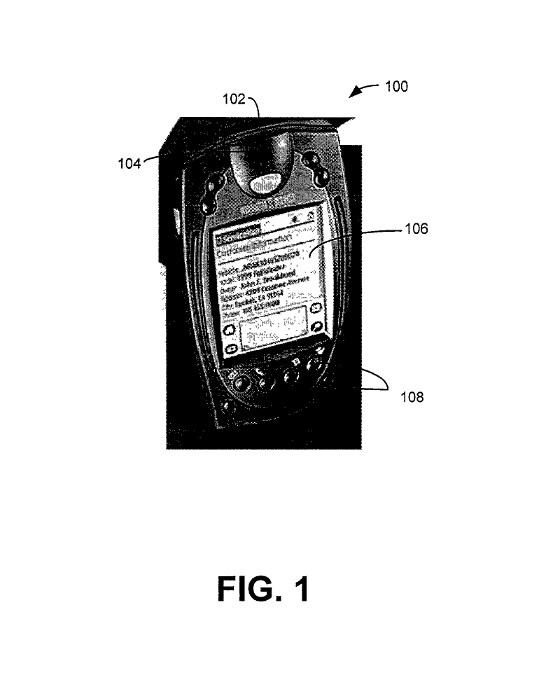

FIG. 1 illustrates a portable device 100 that may be used by a service writer at a dealer service center to scan a vehicle identification number (VIN) from a customer's vehicle and transmit the VIN over a wireless communication link to build a repair order (RO) for the vehicle from one or more databases in a networked computer system. The service writer may display the RO on a display screen of the portable device while the service writer is with the customer in the service drive.

The portable device 100 may include a bar code reader or scanner 102, a wireless transceiver 104, for example a radio frequency (RF) or IR transceiver, a display screen 106, and various data entry and control keys 108. The display screen 106 may be sensitive to a pointing device, for example, a stylus of the type commonly used with palm-type portable computers, or cursor keys may be provided in the housing. The portable device 100 may include a processor that operates on the Palm Computing® platform distributed by the 3Com Corporation, or a similar operating system. According to an embodiment, the portable device 100 may be a hand held device measuring about seven inches in length and weighing about ten ounces.

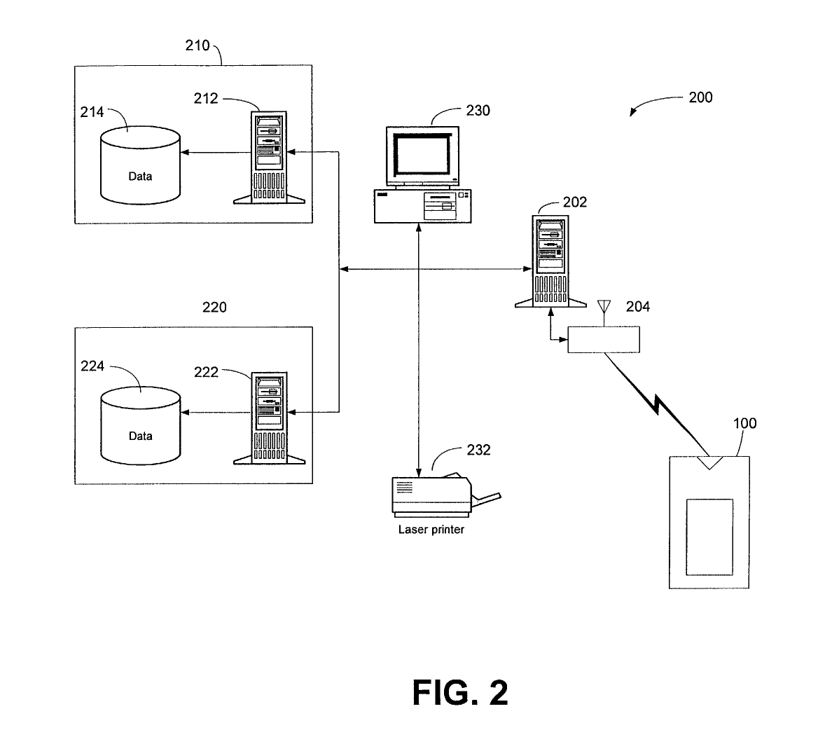

FIG. 2 illustrates a networked computer system 200 according to an embodiment. The system may include a wireless local area network (LAN) server 202 which may include a wireless transceiver 204 for communication with one or more portable devices 100 over a wireless communication link 206. The wireless LAN may operate, for example, in a wireless RF Ethernet transmission mode.

The wireless network server 202 may communicate with a dealer management system (DMS) 210 that includes a DMS server 212 and a DMS database 214 over a wired or wireless LAN connection. The wireless network server 202 may communicate with a manufacturer host computer system 220 that includes a manufacturer server 222 and a manufacturer database 224 over a dedicated communication link, e.g., a dial-up link, digital subscriber line (DSL), a T1 line, a satellite link, or a wide area network (WAN) connection. Exemplary manufacturer host computer systems include, for example, the Nissan North America ServiceCom system, the General Motors Access system, and the Ford Motor Company Oasis system. Such manufacturer host computer systems may also be referred to as dealer communication services (DCS) systems.

The wireless network server 202 may also communicate with an RO generator 230 over the LAN connection. The RO generator 230 may include a general-purpose computer programmed to query the DMS database 214 and the manufacturer database 224 and generate an RO in response to an RO request from the portable device 100. The system 200 may also include a printer 232 at the service center to print a hard copy of the RO generated by the RO generator 230.

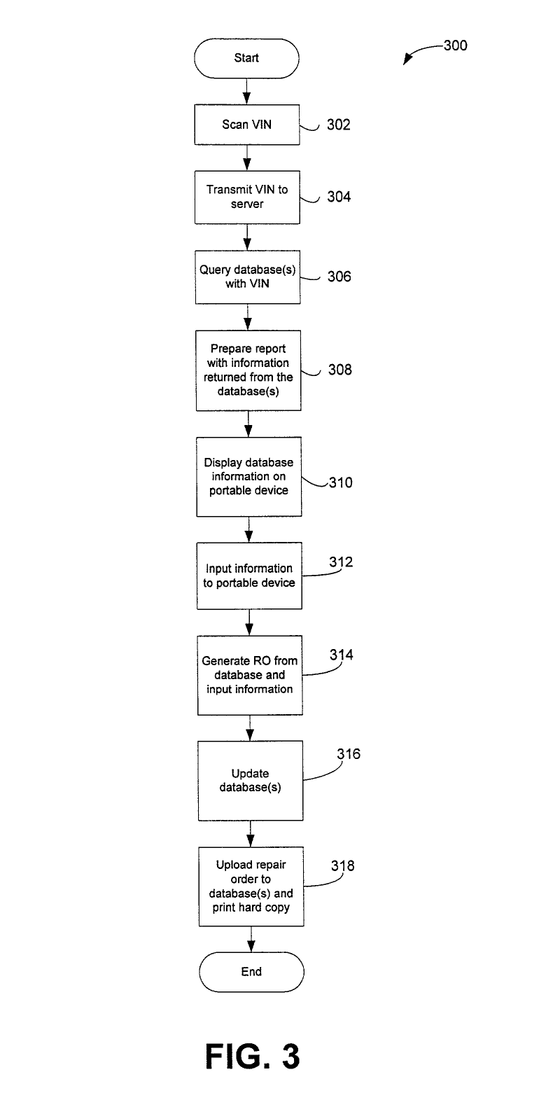

FIG. 3 illustrates a flow chart that describes an operation 300 for generating an RO according to an embodiment. The following description is one embodiment of implementing the operation 300. In other embodiments, blocks may be skipped or performed in a different order.

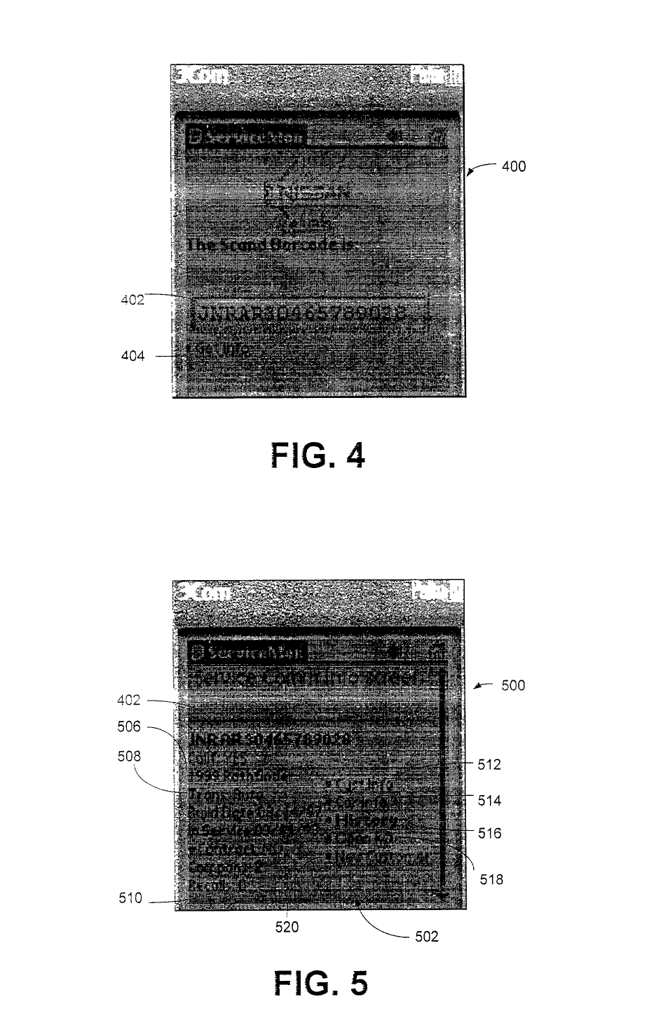

The service writer may scan a bar code on the customer's vehicle with the bar code reader 102 in block 302. The bar code reader may have a range, for example, of about thirty inches. The bar code may identify the VIN of the customer's vehicle. The bar code may be located on a plate attached to, for example, the inside of the driver side door pillar. The portable device 100 may display a screen 400 including the vehicle's VIN 402 on the display screen 106, as shown in FIG. 4. The screen 400 may include a “GET INFO” prompt 404 that the service writer may select to transmit the VIN to the RO generator 230 via the wireless network server 202 in block 304.

The RO generator 230 may query the DMS database 214 and the manufacturer database 224 using the customer vehicle VIN 402 in state 306. The VIN 402 may be unique to the customer's vehicle. The VIN may be stored in the vehicle manufacturer database 224 and associated with information regarding the vehicle's model, production date, equipment package, color, etc. The manufacturer database 224 may include repair information specific to the vehicle, such as warranty terms and benefits, service campaigns, and recalls. The VIN may be stored in the DMS database 214 and associated with other vehicle-specific information including, for example, customer information, production information, and service history.

The customer information may include, for example, the name of the registered owner, customer address, and phone number(s). The production information may include, for example, the vehicle's year, model, color, options, etc. The service history may include, for example, the number of Ros written for the vehicle, last recorded mileage, and cumulative dollars spent for repairs and service at the service center.

The RO generator 230 may merge information returned from the DMS database 214 and/or the manufacturer database 224 into a report in state 308. Information in the report may be accessed via the wireless network server 202 by the portable device 100 for display in state 310.

The portable device 100 may utilize a menu driven application to provide the service writer access to the information returned from the databases. FIG. 5 illustrates a menu 502 with information entries and selectable entries. The information entries may include, for example, the VIN 402, vehicle year and model 504, transmission type 506, build date 508, and recall information 510. The selectable entries may include, for example, a customer information prompt 512, a car information prompt 514, a service history prompt 516, an open RO prompt 518, and a new customer prompt 520.

By selecting the open RO prompt 518, the service writer may input information into the portable device 100 to generate an RO. The service writer may input information into the portable device 100, for example, mileage information, using the input keys 108 and/or the pointing device in block 312. This input information may be transmitted to the wireless network server 202 and used to update one or both of the DMS database 214 and the manufacturer database 224.

The customer may wish to have specific repairs and/or services performed on the vehicle. These other repairs and services may include, for example, routine maintenance, such as an oil change, and other repairs and services not covered under warranty. A menu based file, for example, a pull-down menu, including lists of such repairs and services may be provided on the display screen. The repairs and services may be displayed as textual descriptions or as numeric service codes. The RO generator 230 may also recommend repairs and services based on the information returned from the databases 214, 224 and the information entered by the service writer. For example, the RO generator 230 may recommend an oil change based on the date of the visit and/or the mileage entered by the service writer and the date and/or mileage corresponding to the last recorded oil change performed on the vehicle. The RO generator 230 may recommend repairs and/or services based on recalls and service campaigns currently offered by the manufacturer.

The service writer may input a selection(s) in block 316. This selections(s) may be transmitted to the wireless network server 202 and input to the RO generator 230. The RO generator 230 may use information from the databases and the input information to generate an RO. If the RO is acceptable, a hard copy may be printed at the on-site printer 232 in block 318.

The processing of information, creation of an RO, and the processing of a request from the portable device 100 may be implemented in hardware or software, or a combination of both. Unless otherwise specified, the algorithms described in relation to embodiments are not inherently related to any particular computer or other apparatus.

In particular, various general purpose machines may be used with programs written in accordance with the teachings herein, or it may be more convenient to construct more specialized apparatus to perform the operations. However, preferably, the embodiment is implemented in one or more computer programs executing on interconnected programmable computer systems (e.g., networked client-server systems) each comprising at least one processor, at least one data storage system (including volatile and non-volatile memory and/or storage elements), at least one input device or port, and at least one output device or port. The program code may executed on the processors to perform the functions described herein.

Each such program may be implemented in any desired computer language (including machine, assembly, high level procedural, or object oriented programming languages and web-based mark-up languages) to communicate with a computer system. The language may be a compiled or interpreted language.

Each such computer program may be stored on a storage media or device (e.g., magnetic, optical, or solid state media) readable by a general or special purpose programmable computer, for configuring and operating the computer when the storage media or device is read by the computer to perform the procedures described herein. The system may also be considered to be implemented as a computer-readable storage medium, configured with a computer program, where the storage medium so configured causes a computer to operate in a specific and predefined manner to perform the functions described herein.

The system may be configured to operate on a number of different platforms an protocols including, for example, Systems Network Architecture (SNA) and TCP/IP.

A number of embodiments of the invention have been described. Nevertheless, it will be understood that various modifications may be made without departing from the spirit and scope of the invention. Accordingly, other embodiments are within the scope of the following claims.

What is claimed is:

1. A method for generating a repair order, comprising:
scanning a vehicle identifier on a vehicle;
transmitting the vehicle identifier over a wireless communication link;
retrieving data associated with the vehicle identifier in a memory device; and
generating the repair order from said data.

2. The method of claim 1, further comprising transmitting the repair order to a portable device over the wireless communication link.

3. The method of claim 2, further comprising displaying the repair order on a display screen of the portable device.

4. The method of claim 1, wherein the vehicle identifier comprises a Vehicle Identification Number (VIN).

5. The method of claim 1, wherein said scanning the vehicle identifier comprises scanning a bar code indicative of the vehicle identifier.

6. The method of claim 1, wherein said retrieving data comprises querying a database with said vehicle identifier.

7. The method of claim 6, wherein the database includes production information associated with the vehicle identifier.

8. The method of claim 6, wherein the database includes customer information associated with the vehicle identifier.

9. The method of claim 6, wherein the database includes warranty information associated with the vehicle identifier.

10. The method of claim 6, wherein the database includes vehicle service history information associated with the vehicle identifier.

11. The method of claim 1, further comprising:
entering user input information into the portable device; and
transmitting said user input information over the wireless communication link.

12. The method of claim 11, further comprising generating a new repair order in response to said user input information.

13. The method of claim 11, further comprising updating the memory device with said user input information.

14. An apparatus comprising:
a scanner to scan a vehicle identifier;
a transmitter to transmit the vehicle identifier over a wireless communication link;
a receiver to receive a repair order generated in response to said vehicle identifier over said wireless communication link; and
a display screen to display the repair order.

15. The apparatus of claim 14, further comprising a portable housing.

16. The apparatus of claim 14, wherein said transmitter and said receiver are integrated into a transceiver.

17. The apparatus of claim 14, wherein the scanner comprises an infrared scanner.

18. The apparatus of claim 14, wherein the vehicle identifier comprises a bar code, and wherein the scanner comprises a bar code scanner.

19. A networked computer system comprising:
a portable device comprising:
a scanner to scan a vehicle identifier;
a transmitter to transmit the vehicle identifier over a wireless communication link;
a receiver to receive a repair order generated in response to said vehicle identifier over said wireless communication link; and
a display screen to display the repair order;
and
a database including vehicle information associated with said vehicle identifier; and
a repair order generator in communication with the portable device over the wireless communication link and in communication with the database, said repair order generator operative to query the database with the vehicle identifier and generate a repair order from the vehicle information accessed in response to said query.

20. The system of claim 19, wherein the vehicle information comprises owner information.

21. The system of claim 19, wherein the vehicle information comprises production information.

22. The system of claim 19, wherein the vehicle information comprises warranty information.

23. The system of claim 19, wherein the vehicle information comprises service campaign information.

24. The system of claim 19, wherein the vehicle information comprises recall information.

25. The system of claim 19, wherein the vehicle information comprises service history information.

26. The system of claim 19 wherein the vehicle identifier comprises a bar code, and said scanner comprises a bar code scanner.

27. An apparatus, including instructions residing on a machine-readable medium, for generating a repair order, said instructions causing the machine to:
scan a vehicle identifier on a vehicle;
transmit the vehicle identifier over a wireless communication link;
retrieve data associated with the vehicle identifier in a memory device; and
generate the repair order from said data.

28. The method of claim 27, further comprising instructions that cause the machine to transmit the repair order to a portable device over the wireless communication link.

29. The method of claim 27, further comprising instructions that cause the machine to display the repair order on a display screen of the portable device.

30. The method of claim 27, wherein the instructions that cause the machine to scan the vehicle identifier comprise instructions that cause the machine to scan a bar code indicative of the vehicle identifier.

31. The method of claim 27, wherein the instructions that cause the machine to retrieve data comprise instructions that cause the machine to query a database with said vehicle identifier.
